(19) United States
(12) Patent Application Publication
(10) Pub. No.: US 2013/0118906 A1
(43) Pub. Date: May 16, 2013

(54) METHOD AND SYSTEM FOR ENHANCING CATALYTIC AND PHOTOCATALYTIC PROCESSES

(71) Applicant: UNIVERSITY OF SOUTHERN CALIFORNIA, Los Angeles, CA (US)

(72) Inventors: Stephen Cronin, Los Angeles, CA (US); Wenbo Hou, El Cerrito, CA (US); Zuwei Liu, San Jose, CA (US); Prathamesh Pavaskar, Alhambra, CA (US)

(73) Assignee: UNIVERSITY OF SOUTHERN CALIFORNIA, Los Angeles, CA (US)

(21) Appl. No.: 13/679,652

(22) Filed: Nov. 16, 2012

Related U.S. Application Data
(60) Provisional application No. 61/560,661, filed on Nov. 16, 2011.

(51) Int. Cl. C25B 11/04; C25B 3/00

(52) U.S. Cl. CPC C25B 11/0405; C25B 3/00; B82Y 30/00
USPC 205/340; 204/242; 977/784

(57) ABSTRACT

A system for solar energy conversion includes a photoelectric cell. The photoelectric cell includes a cathode and an anode comprising a nanostructure array. The nanostructure array includes a semiconductor photocatalyst; and a plasmon resonant metal nanostructure film arranged on the semiconductor photocatalyst. The system is used in a method to produce methane by placing a photocatalytic cell in an environment containing CO₂; and exposing the photocatalytic cell to visible light thereby allowing the CO₂ to be converted to methane.

### CROSS-REFERENCE TO RELATED APPLICATION(S)

The present application is based upon and claims the benefit of priority from U.S. Provisional Patent Application 61/560,661 (Attorney Docket No. 28080-693), filed on Nov. 16, 2011, the entire contents of which are incorporated by reference herein.

### STATEMENT REGARDING FEDERALLY SPONSORED RESEARCH

This invention was made with government support under Grant No. FA9550-08-1-0019, awarded by the Air Force Office of Scientific Research (AFOSR); under Grant No. N00014-08-1-0132, awarded by the Office of Naval Research (ONR); under Grant No. W911NF-09-1-0240, awarded by the Army Research Office (ARO); and under Grant No. CBET-0846725, awarded by the National Science Foundation (NSF). The Government has certain rights in the invention.

### BACKGROUND

Solar energy presents a promising alternative to fossil fuels as an abundant, largely untapped resource. The amount of energy striking the Earth from sunlight in one hour (4.3×10²⁰ J) is more than the total energy consumed on this planet in one year (4.1×10²⁰ J). Despite this, only 0.1% of the world's electricity was solar generated in 2001.

Utilizing solar electricity for large scale energy generation presents several problems. First, as an intermittent energy source (night and day), there is no way to effectively store this enormous amount of electricity each day to be used during the night. Batteries give the option of storing limited amounts of energy, but suffer from finite lifetimes and contain significantly toxic chemicals that are difficult to dispose of. Also, there are huge losses associated with transporting electricity over large distances. Therefore, a method of storing the sun's energy in chemical bonds then releasing it without harmful byproducts is indeed the “Holy Grail” in solar energy conversion.

Macroscopic catalysts are based on traditional chemical pathways. At the nanoscale, the catalytic properties of materials are often quite different from their bulk counterparts. For example, gold is considered to be a poor catalyst for most applications. However, gold nanoparticles on metal oxide supports demonstrate high catalytic activity even at room temperature. Thus, there is great potential for new chemical pathways at the nanoscale.

Additional catalytic enhancement may be produced by the surface plasmon resonance phenomenon. Plasmons are the collective oscillation of the free charge in a conducting material. Light below the plasma frequency is reflected because the electrons in the metal screen the electric field of the light. Light above the plasma frequency is transmitted because the electrons cannot respond fast enough to screen it. Surface plasmons are those oscillations that are confined to the surfaces of conducting materials and interact strongly with light. A resonance in the absorption occurs at the plasmon frequency when the real part of the dielectric function goes to zero. Irradiating metal nanoparticles with light at their plasmon frequency generates intense electric fields at the surface of the nanoparticles.

The frequency of this resonance can be tuned by varying the nanoparticle size, shape, material, and proximity to other nanoparticles. For example, the plasmon resonance of silver, which lies in the UV, can be shifted into the visible range by making the nanoparticle size very small. Similarly, the plasmon resonance of gold in the visible range can be brought into the infrared wavelength range by minimizing the nanoparticle size.

Nurmikko and others have fabricated arrays of nanoparticles with different spacing using electron beam lithography. Their optical measurements show that the plasmon resonance increases asymptotically as the particles are brought closer together. This was corroborated by the calculations of Schatz et al. using an interacting dipole model that showed the plasmonic resonance to be 10³ times stronger between two nearly touching nanoparticles. The intense electric fields produced near plasmon resonant metallic nanoparticles are currently utilized in surface enhanced Raman spectroscopy (SERS) to produce enhancement factors as high as 10¹⁴. Numerical simulations have predicted SERS enhancement factors up to 10¹⁰. Also, surface plasmon resonance is used by biochemists to study the mechanisms and kinetics of ligands binding to receptors.

Metal oxides such as TiO₂, YbO, PbO may be used as photocatalysts for a number of applications, including solar fuel production, oxidation of pollutants, and anti-fogging/self-cleaning coatings for windows and lenses. When gold is dispersed as fine particles (2-5 nm) over select metal oxides, it may exhibit exceptionally high catalytic activity, far exceeding that of the metal oxide and gold catalysts separately. Examples of this enhanced catalytic activity include the following: hydrogen production from water, oxidation of volatile organic compounds (VOCs), CO oxidation, hydrocarbon combustion, hydrogenation of CO₂ and CO, water gas shift reaction, and reduction of NO to N₂. Quite often these reactions occur at low or subambient temperatures.

Recent work of Haruta has shown that the catalytic performance and selectivity of metal oxide supported gold nanoparticles can be dramatically tuned by controlling the nanoparticle size. While these results demonstrate that charge transfer from the nanoparticles to the metal oxide is possible, the details of this mechanism are not fully understood.

TiO₂ is one of the most promising photocatalysts; however, it does not absorb light in the visible region of the electromagnetic spectrum. Because TiO₂ has a short wavelength cutoff, there are very few solar photons (˜4%) that can be used to drive this photocatalyst. Several attempts to extend the cutoff wavelength of this material have resulted in slightly improved efficiencies, but the efficiency is not sufficient for everyday uses.

### SUMMARY

The present disclosure is directed toward a system and method to enhance catalytic and photocatalytic processes under solar irradiation by integrating plasmon resonant nanostructures with strongly catalytic materials.

In one embodiment of the present disclosure, a system for solar energy conversion comprises a photoelectric cell. The photoelectric cell comprises a cathode; and an anode comprising a nanostructure array. The nanostructure array may comprise a semiconductor photocatalyst; and a plasmon resonant metal nanostructure film arranged on the semiconductor photocatalyst.

In another embodiment of the present disclosure, a method for producing methane comprises the steps of placing a photocatalytic cell in an environment containing CO₂; and exposing the photocatalytic cell to visible light thereby allowing the CO₂ to be converted to methane. The photoelectric cell comprises a cathode; and an anode comprising a nanostructure array. The nanostructure array comprises a semiconductor photocatalyst; and a plasmon resonant metal nanostructure film arranged on the semiconductor photocatalyst.

Additional advantages and other features of the present disclosure will be set forth in part in the description which follows and in part will become apparent to those having ordinary skill in the art upon examination of the following or may be learned from the practice of the disclosure. The advantages of the disclosure may be realized and obtained as particularly pointed out in the appended claims.

As will be realized, the present disclosure is capable of other and different examples, and its several details are capable of modifications in various obvious respects, all without departing from the disclosure. Accordingly, the drawings and description are to be regarded as illustrative in nature, and not as restrictive.

### BRIEF DESCRIPTION OF THE DRAWINGS

FIG. 1 is an illustration of a system for solar energy conversion according to one embodiment of the present disclosure.

FIGS. 2a-d are an SEM image of a 5 nm thick Au island film and a corresponding electric field intensity at the interface of an Au—TiO₂ film at the resonance calculated using FDTD according to another example of the present disclosure.

FIGS. 3a-b are photocurrents of anodic TiO₂ with and without Au nanostructures at zero bias voltage irradiated with (a) UV (A=254 nm) and (b) visible light (A=532 nm) for 22 seconds according to another example of the present disclosure.

FIG. 4 is a photocurrent of anodic TiO₂ with and without Au nanoparticles irradiated with A=633 nm light for 22 seconds according to another example of the present disclosure.

FIG. 5 is a UV-Vis absorption spectra of TiO₂ with and without gold nanoparticles according to another example of the present disclosure.

FIG. 6 is a schematic diagram of three types of sample geometries of metal/metal oxides on substrates according to another example of the present disclosure.

FIGS. 7a-b are graphical representations of photocatalytic product yields (after 15 h of visible irradiation) on three different catalytic surfaces and energy band alignment of anatase TiO₂, Au, and the relevant redox potentials of CO₂ and H₂O under visible illumination according to another example of the present disclosure.

FIGS. 8a-b are graphical representations of photocatalytic product yields (after 15 h of 254 nm UV irradiation) on three different catalytic surfaces, an energy band alignment of anatase TiO₂, Au, and the relevant redox potentials of CO₂ and H₂O under 254 nm UV illumination.

FIG. 9 is a graphical representation of photocatalytic product yields of 5 nm Pt on glass and a Cu foil compared with that of 5 nm Au on glass according to another example of the present disclosure.

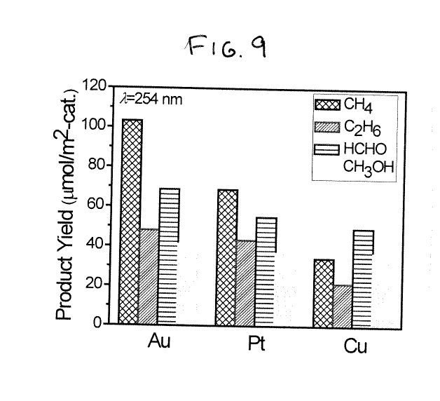

FIGS. 10a-c are Au nanoparticle arrays with various geometries fabricated by electron beam lithography according to another example of the present disclosure.

### DETAILED DESCRIPTION

Illustrative examples are now discussed and illustrated. Other examples may be used in addition or instead. Details which may be apparent or unnecessary may be omitted to save space or for a more effective presentation. Conversely, some examples may be practiced without all of the details which are disclosed.

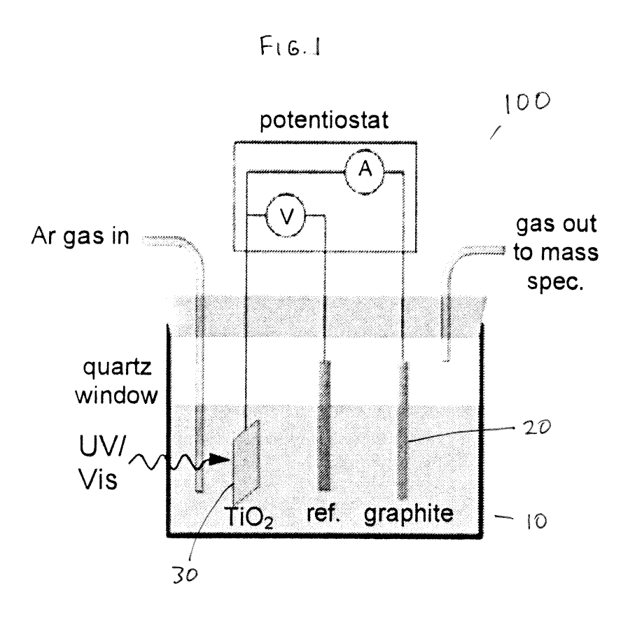

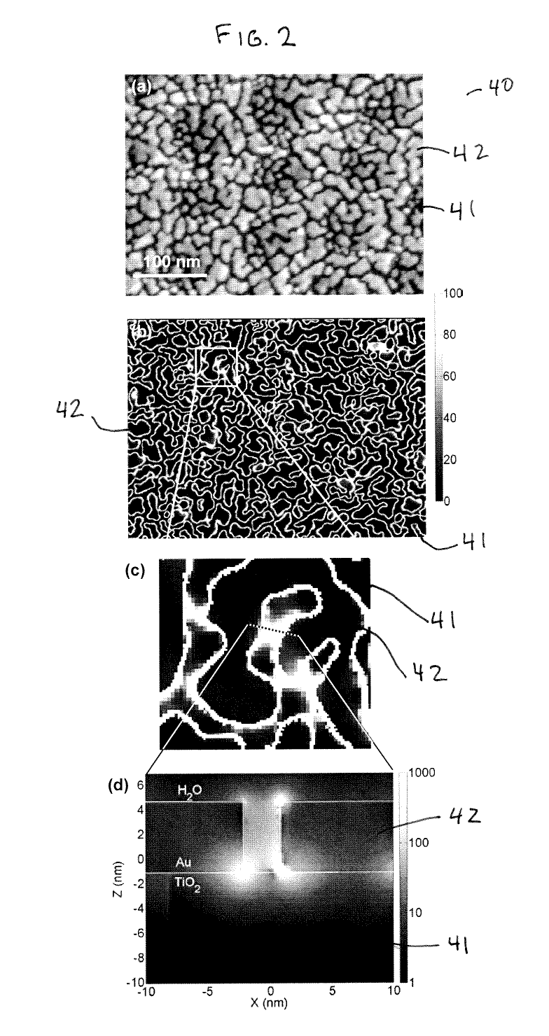

FIG. 1 show a system for solar energy conversion according to one embodiment of the present disclosure. The system 100 for solar energy conversion includes a photoelectric cell 10 comprising a cathode 20; and an anode 30 comprising a nanostructure array 40. As shown in FIGS. 2a-d, the nanostructure array comprises a semiconductor photocatalyst 41, and a plasmon resonant metal nanostructure film 42 arranged on the semiconductor photocatalyst.

Any suitable method may be used for making the nanostructure array. Several methods exist for producing nanostructure arrays, including block copolymer lithography (BCPL), electron beam lithography, and colloidal nanoparticle deposition. In one example of the present disclosure, arrays of plasmon resonant metal nanostructures, for example, Au or Ag nanoparticles, are produced by using thin film evaporation (5-6 nm). Since a 6 nm deposition of Ag or Au is not enough to form a complete continuous film, nanometer-sized islands of strongly plasmonic plasmon resonant metal 42 are formed on the semiconductor photocatalyst 41. The island-shaped areas 42 may have a size of about 10 nm to about 30 nm in diameter. The island-shaped areas 42 may be separated from each other by a distance of about 1 nm to about 10 nm.

The plasmon resonant metal nanostructure film may be of any suitable plasmonic metal capable of catalytic solar power conversion. Suitable plasmonic metals for use in the present disclosure may include, but are not limited to, Au, Ag, Al, Cu and Pt, and combinations thereof.

Any suitable semiconductor photocatalyst may be used for the photoelectric cell of the present disclosure. Suitable semiconductor photocatalysts include TiO₂, YbO, PbO, Fe₂O₃, ZnO, CdS, SiC, WO₃, and GaP. In one embodiment of the present disclosure, TiO₂ in the anatase crystalline phase was used.

The TiO₂ was prepared by electrochemically oxidizing titanium foil in an ethylene glycol electrolyte containing 0.25 wt % NH₄F and 2% wt H₂O at an anodization potential of 30 V for two hours. A graphite rod may be used as the cathode 20. However, any suitable material may be used for as the cathode. A gold film with a nominal thickness of 5 nm was then evaporated on the surface of the TiO₂. This thin gold film may form island-like growth that is strongly plasmonic.

The underlying mechanism of enhancement may be understood by simulating the electromagnetic response of these Au nanoparticle/TiO₂ composite films using the finite difference time-domain (FDTD) method. For example, FIG. 2a shows a scanning electron microscope (SEM) image of a gold nanoparticle-island film 42 deposited on top of anodic TiO₂ 41. The electromagnetic response of this film 42, as shown in FIGS. 2b-d, is dominated by local “hot spots” that can be seen between nearly touching Au nanoparticles. FIG. 2d shows a cross-sectional plot of the electric field distribution of one of these hot spot regions in the z-dimension. In this hot spot region, the electric field intensity at the TiO₂ surface reaches 1000 times that of the incident electric field intensity. This means that the photoabsorption (and hence electron-hole pair generation) rate is 1000 times higher than that of the incident electromagnetic radiation. This is particularly advantageous considering the small crystal grain sizes in anodic TiO₂, which limits the exciton diffusion length to ˜10 nm. As a result of this, only photons absorbed within 10 nm of the TiO₂ surface will contribute to the photocatalytic splitting of water. Here, the plasmonic nanoparticles couple light very effectively from the far-field to the near-field at the TiO₂ surface. Consequently, most of the photogenerated charge created by the plasmon excitation will contribute to the surface catalysis in, for example, the cleavage of water into hydrogen and oxygen.

Despite the fact that these hot spot regions, shown in FIG. 2b, comprise a very small fraction of the total catalytic surface area, it is remarkable that a net improvement in the photocatalytic water splitting with the addition of a gold nanoparticle film 42 is observed. The reason for this remarkably robust enhancement lies in the short exciton diffusion lengths of these anodic TiO₂ films. The near-field optical enhancement provided by the Au nanoparticles is well-matched to this defect-rich material, which has very short exciton diffusion lengths that would otherwise spoil its photocatalytic performance. And, as stated above, virtually all of the photogenerated charge excited by these plasmon-enhanced fields contributes to the photocatalytic reaction.

Doping or defects may be used to enable light absorption below the bandgap, however, these dopants shorten the exciton diffusion lengths in this material, and this ultimately spoils its photocatalytic performance. The plasmon enhancement mechanism, described here, provides a way around this. Here, the plasmonic nanoparticles may provide a new degree of freedom in the optimization of photocatalytic materials, in which the photocatalytic activity of large bandgap semiconductors, like TiO₂, can be extended into the visible region of the electromagnetic spectrum.

Absorption spectra of the bare TiO₂ and Au nanoparticle/TiO₂ films were recorded on a Perkin-Elmer Lambda 950 UV/Vis/NIR with an integrating sphere detector. The photocatalytic reaction rates of TiO₂ with and without Au nanoparticles are measured in a 1M KOH solution using a three-terminal potentiostat, with the TiO₂ film, a Ag/AgCl electrode, and a graphite electrode functioning as the working, reference, and counter electrodes, respectively, as shown schematically in FIG. 1. The TiO₂ film is irradiated in a sealed quartz flask, to generate the production of H₂ under UV illumination. The photocurrent gives a direct measure of the H₂ production rate, with every two electrons producing one H₂ molecule.

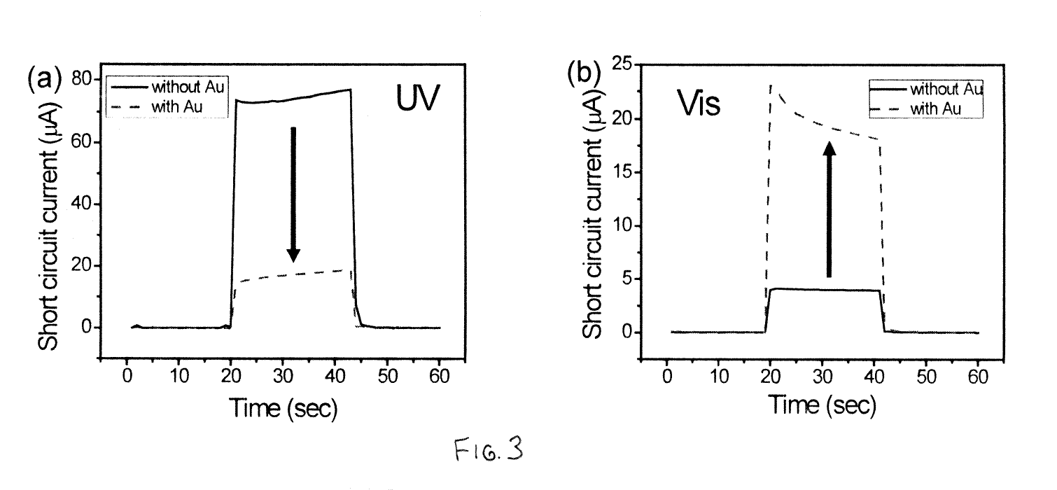

FIG. 3a shows the photocurrent of anodic TiO₂ with and without Au nanoparticles irradiated with ultraviolet (20 mW/cm²@254 nm) and visible light (7 W/cm²@532 nm) for 22 seconds. Under UV illumination as shown in FIG. 3a, the addition of gold nanoparticles results in a 4-fold reduction in the photocurrent. This reduction is due to the presence of the gold nanoparticles, which significantly reduce the TiO₂ surface area in direct contact with the aqueous solution. Under visible irradiation (x=532 nm) as shown in FIG. 3b however, the addition of gold nanoparticles results in a 5-fold increase in the photocurrent due to the large plasmonic enhancement of the incident electromagnetic fields. Considering the 25% reduction in active TiO₂ surface area, based on the 4-fold reduction in FIG. 3a, this plasmonic enhancement corresponds to a factor of 20× increase in the photocatalytic performance of the exposed TiO₂. The transient decay observed in FIG. 3b is the result of trapped surface charge that is released upon irradiation.

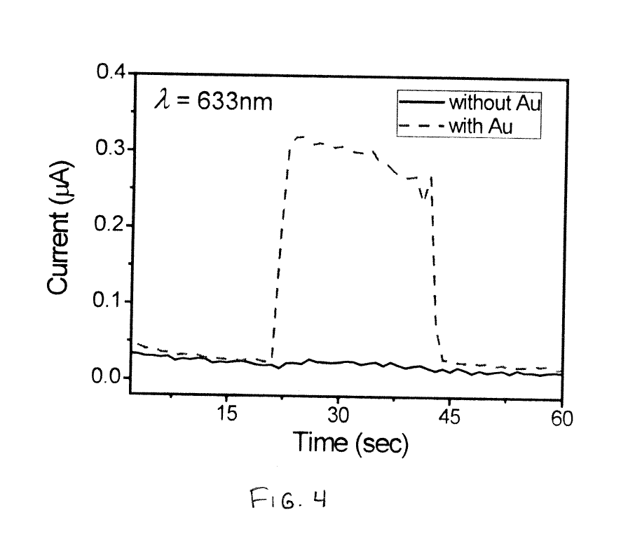

The photocatalytic enhancement when irradiated with 633 nm light is shown in FIG. 4, which is significantly below the bandgap of TiO₂. Unlike 532 nm light, no detectible photocurrent can be observed for bare TiO₂ with no nanoparticles. However, significant enhancement in the photocurrent is demonstrated for samples with plasmonic nanoparticles deposited on top of TiO₂, resulting in a photocurrent on the order of 1 μA, with a laser power of 9 mW and spot size of 3 mm. As a lower limit for the photocatalytic enhancement factor at 633 nm may be obtained by taking the unenhanced photocurrent to equal the noise in the photocurrent (4.5 nA), the lower limit for the enhancement factor is on the order of 66×.

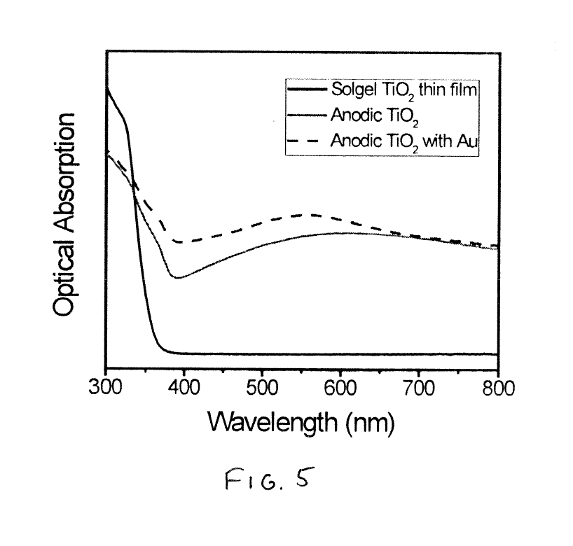

FIG. 5 shows the UV-Vis absorption spectra of TiO₂ with and without gold nanoparticles. The spectrum taken for an undoped TiO₂ film prepared by the solgel method shows transparency for wavelengths above 370 nm. However, the anodic TiO₂ film shows significant absorption in the visible range (at longer wavelengths), likely due to N- and F-impurities produced during the anodization process, which produce defect states in the bandgap. The absorption spectrum taken from anodic TiO₂ with gold nanoparticles (dashed curve) exhibits a slight increase in the absorption in the visible light range. The broad absorption of the Au film is a result of the inhomogeneity of these plasmonic nanoparticles, as can be seen in FIG. 2a.

Another embodiment of the present disclosure includes a method for producing methane by use of a photocatalytic cell. The method comprises placing a photocatalytic cell in an environment containing CO₂; and exposing the photocatalytic cell to visible light thereby allowing the CO₂ to be converted to methane. In the present embodiment, the photoelectric cell comprises a cathode; and an anode comprising a nanostructure array. The nanostructure array comprises a semiconductor photocatalyst; and a plasmon resonant metal nanostructure film arranged on the semiconductor photocatalyst.

Thus, photocatalytic conversion of CO₂ to methane and other hydrocarbon fuels may be performed by using the solar fuel system of the present disclosure. When the incident photon energy matches the plasmon resonance of the Au nanoparticles (free carrier absorption), which is in the visible range (532 nm), a 24-fold enhancement in the photocatalytic activity due to the intense local electromagnetic fields created by the surface plasmons of the Au nanoparticles is observed. These intense electromagnetic fields enhance sub-bandgap absorption in the TiO₂, thereby enhancing the photocatalytic activity in the visible range. When the photon energy is high enough to excite d band electronic transitions of Au, in the UV range (254 nm), a different mechanism occurs resulting in the production of additional reaction products, including C₂H₆, CH₃OH, and HCHO. This occurs because the energy of the d band excited electrons lies above the redox potentials of the additional reaction products CO₂/C₂H₆, CO₂/CH₃OH, and CO₂/HCHO. We model the plasmon excitation at the Au nanoparticle-TiO₂ interface using finite difference time domain (FDTD) simulations, which provides a rigorous analysis of the electric fields and charge at the Au nanoparticle-TiO₂ interface.

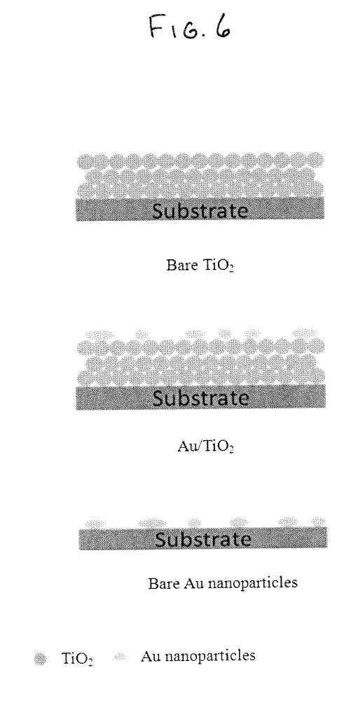

In the reduction of this method to practice, three basic sample types are fabricated and characterized: 1) bare TiO₂, 2.) Au nanoparticles deposited on top of TiO₂, and 3.) bare Au nanoparticles, as depicted in FIG. 6. Anatase titania thin films may be prepared by the sol-gel process and acid catalyzing dilute titanium ethoxide in ethanol. The solution may then be mixed with surfactant (P123) and stirred for several hours until a sol forms. Substrates of glass or quartz are spin-coated to achieve the desired film thickness of 400 nm. The substrates are then positioned horizontally and dried at room temperature in air for 24 h, thereby allowing most of the solvents and hydrochloric acid to evaporate and the surfactant to self-organize. The dried films are then annealed at 400° C. in air for 4 h to improve their crystallinity and drive off any remaining solvents and surfactant.

Raman and XRD spectra of the resulting TiO₂ show that anatase TiO₂ is obtained. A thin film of gold is deposited on the TiO₂ surface in vacuum using electron beam evaporation, while the film thickness is monitored with a crystal oscillator. A 5 nm deposition of gold is not thick enough to form a continuous film and, instead, produces an island-like morphology that is known to be strongly plasmonic. A high resolution transmission electron microscope (TEM) image of a 5 nm Au film is shown in FIG. 2a. Subsequent annealing of this island-like film at 400° C. in air for 1 h produces more spherical Au nanoparticles. As discussed above, thin Au evaporated films (˜5 nm) are known to form island-like growth. In order to make bare Au nanoparticles on an inactive support, a gold film with a thickness of 5 nm may be evaporated on the surface of the glass.

Absorption spectra of the bare TiO₂ and Au nanoparticle/TiO₂ films are recorded on a Perkin-Elmer Lambda 950 UV/Vis/NIR spectrophotometer with an integrating sphere detector. The photocatalytic reduction of CO₂ and H₂O are carried out in a sealed 51.6 ml stainless steel reactor with a quartz window for the three basic sample types described above. The photocatalytic films are placed on the catalyst holder, which is on the bottom of the reactor. The reactor is first purged with CO₂ saturated water vapor for 1 h before closing the system. The reactor is then illuminated with either UV light (254 nm 20 mW/cm² or 365 nm 20 mW/cm² UV lamp) or visible light (532 nm 350 mW/cm² green laser) for 15 h at 75° C. The irradiated surface area is limited by the surface area of the photocatalysts (10 cm²). Reaction products are analyzed using a Varian gas chromatograph (GC) equipped with TCD (with a detection limit of 100 ng for CO₂) and FID (with a detection limit of 50 pg for small organic molecules) detectors. The GC is calibrated by a series of gas samples with known amounts of CH₄, CH₃OH, HCHO, and C₂H₆.

300 μL of gas (products and unreacted reagents) is sampled after 15 h of illumination for each reaction. Since only 300 μL of unreacted reagents and products are sampled and tested using GC, the yields are calculated by normalizing to the full volume of the reactor (51.6 ml).

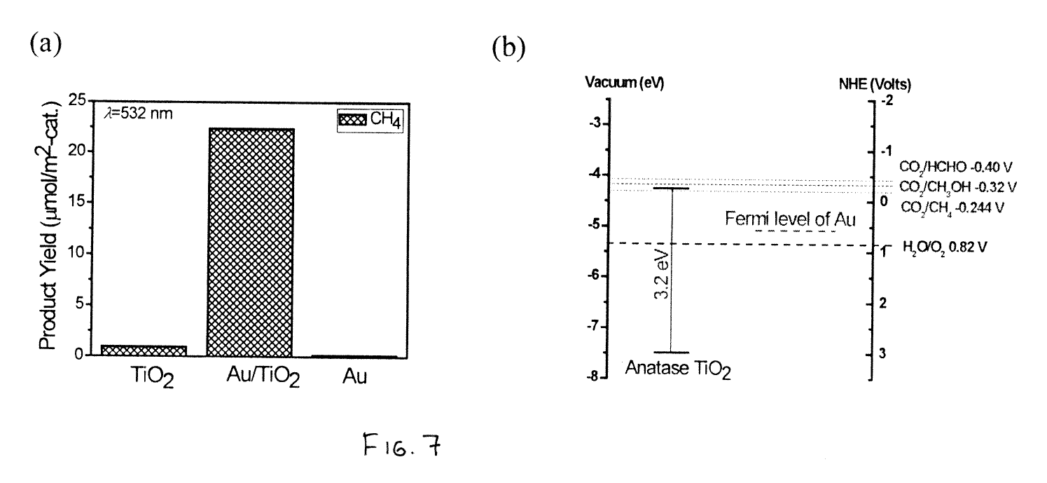

FIG. 7a shows the product yields of the photoreduction of aqueous CO₂ expressed per 1 m² of catalyst surface area after 15 h visible (532 nm laser) illumination. Here, methane is the only product detected by the GC for the three basic sample types, bare sol-gel TiO₂, Au nanoparticle/TiO₂, and bare Au nanoparticles. These reactions can be understood by comparing the conduction and valence band energies of TiO₂ with the reduction potentials of CO₂ for the three reduction products CH₄, HCHO, and CH₃OH, as shown in FIG. 7b. Since the conduction band of TiO₂ lies above the reduction potential of CO₂/CH₄, it is energetically favorable for electrons from the conduction band of TiO₂ to transfer to CO₂ to initiate the reduction of CO₂ with H₂O producing CH₄. Methane is the only favorable product since the reduction potentials of CO₂/HCHO and CO₂/CH₃OH lie above the conduction band of TiO₂. For the bare TiO₂-catalytzed reduction, only a small amount of methane is detected by GC since the energy of the 532 nm wavelength light (2.41 eV) is significantly lower than the bandgap of TiO₂ (3.2 eV). The yield is finite, yet small (0.93 μmol/m²-cat.), because of electronic transitions excited to and from defect states in the bandgap of TiO₂. On the other hand, the yield of Au nanoparticle/TiO₂-catalyzed reduction is 22.4 μmol/m²-cat., a 24-fold enhancement over the bare constituent materials.

As a control experiment, bare Au nanoparticles without TiO₂ were also tested and found to exhibit a negligible photocatalytic yield (FIG. 7a), indicating the importance of the TiO₂ surface in this catalytic process. This result agrees well with our previous studies. Under visible illumination, electron-hole pairs are generated by the sub-band transitions in TiO₂, instead of in Au. Plasmon-excited electrons in Au nanoparticles are not be able to transfer to the either TiO₂ or the reagents.

The UV-vis absorption spectrum taken for a bare TiO₂ film prepared by the sol-gel method shows transparency for wavelengths above 387 nm, which corresponds to the bandgap of anatase TiO₂ (3.2 eV). While the UV-vis absorption spectra of the bare sol-gel TiO₂ shows no apparent absorption below the bandgap, finite sub-bandgap absorption does occur due to a small concentration of defect states in the bandgap due to a Ti⁴⁺ stoichiometry deficiency, thus, enabling electron-hole pair generation at 532 nm.

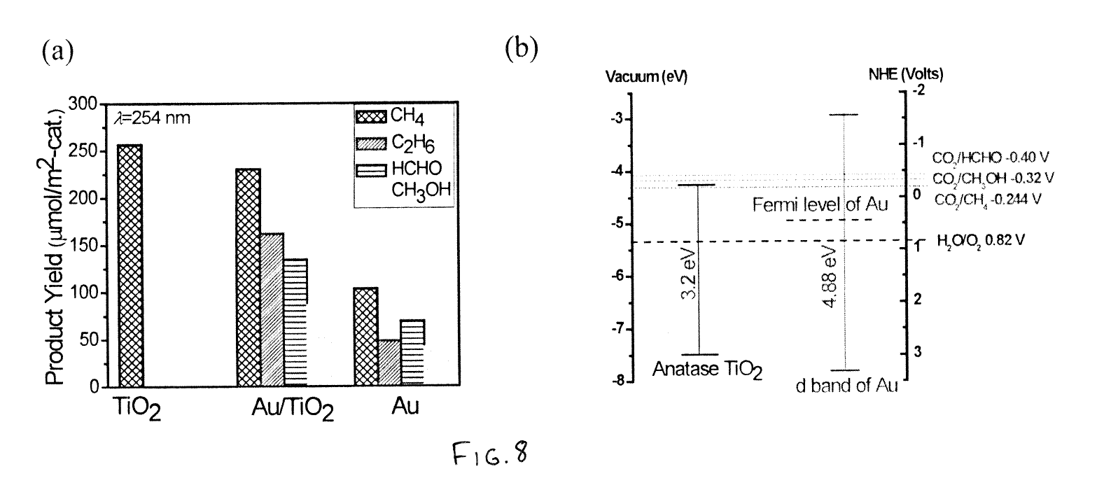

This reaction was also characterized under UV irradiation. FIG. 8 shows the product yields of the photoreduction of aqueous CO₂ expressed per 1 m² of catalyst surface area after 15 h UV (254 nm mercury lamp) illumination. For the bare TiO₂ catalyst, methane is the only product detected by GC. However, additional reaction products, including ethane, formaldehyde, and methanol, are observed for the Au nanoparticle/TiO₂-catalyzed reactions. The same four reaction products upon illumination of bare Au nanoparticles are deposited on glass, indicating that the reaction is now taking place on the Au surface.

Thus, plasmonic enhancement of the photocatalytic reduction of CO₂ with H₂O under visible illumination is observed when Au nanoparticles are deposited on the surface of TiO₂. This enhancement is due to the strong electric fields created by the surface plasmon resonance of the Au nanoparticles, which excite electron-hole pairs locally in the TiO₂ at a rate several orders of magnitude higher than the normal incident light. When the photon energy is high enough to excite the d band electrons of Au to a conduction band that lies above the conduction band of TiO₂, direct charge transfer occurs between these two materials. When the incident photon energy is high enough (254 nm UV), an additional mechanism involving the interband electric transitions in Au produces a number of additional photocatalytic reaction products. In this wavelength range, both the excited electrons in Au and TiO₂ contribute to the reduction of CO₂ with H₂O vapor to form methane and other materials.

The semiconductor photocatalyst may be doped with a dopant selected from the group consisting of V, Cr, Mn, Fe, Ni, N, any ions thereof and any combinations thereof. Doping provides a way to further improve the photocatalytic enhancement mechanism by creating impurity states, which enable subbandgap absorption of light. Doping of TiO₂ with metal ions can increase the photocatalytic activity of TiO₂ in the visible range. N-doping may also increase the visible light activity of TiO₂. N-doping of TiO₂ shifts the photoactivity of TiO₂ into the visible range (>500 nm).

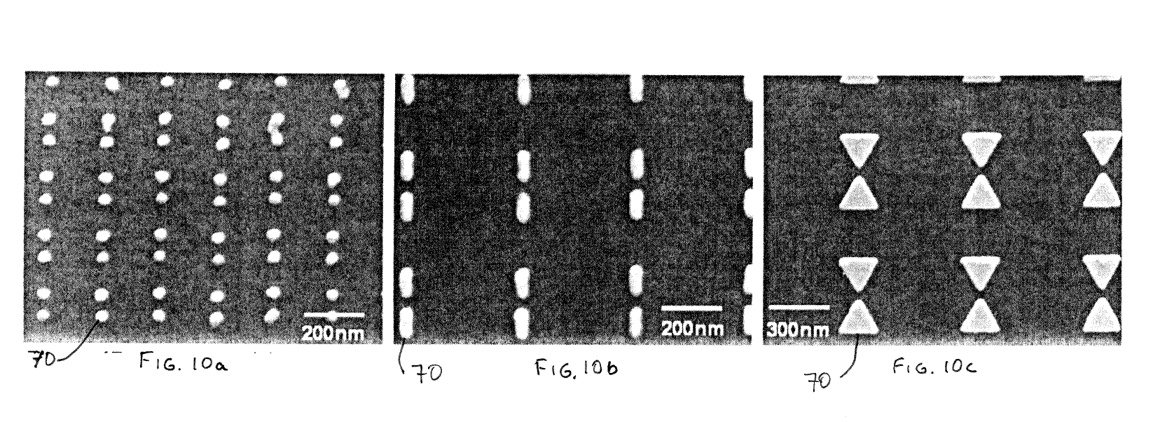

In other embodiments of the present disclosure, the nanostructure array may have a repeating pattern of shapes 70. Electron beam lithography (EBL) provides an alternate method for fabricating well-defined nanostructure geometries over an extensive range of size, shape, separation, and material. In particular, EBL offers a means of accurately studying coupled plasmonic systems, which are more strongly resonant than individual nanoparticles. We have fabricated and tested several arrays of nanostructures created by electron beam lithography. FIGS. 10a-c show scanning electron microscope (SEM) images of coupled nanodot, rod, and triangle arrays, patterned in Au using electron beam lithography. With this fabrication technique, hundreds of different patterns may be generated on a single chip. The different nanostructure geometries or shapes 70 may include coupled dots, rods, triangles, bowties, and crescents, varied over a wide range of size, separation, and material, such as Au, Ag, Pt, Cu and Al. In some embodiments, the shapes 70 have a size of from 10 to about 150 nm as measured along the longest axis.

The present disclosure can be practiced by employing conventional materials, methodology and equipment. Accordingly, the details of such materials, equipment and methodology are not set forth herein in detail. In the previous descriptions, numerous specific details are set forth, such as specific materials, structures, chemicals, processes, etc., in order to provide a thorough understanding of the disclosure. However, it should be recognized that the present disclosure can be practiced without resorting to the details specifically set forth. In other instances, well known processing structures have not been described in detail, in order not to unnecessarily obscure the present disclosure.

Only a few examples of the present disclosure are shown and described herein. It is to be understood that the disclosure is capable of use in various other combinations and environments and is capable of changes or modifications within the scope of the inventive concepts as expressed herein.

The components, steps, features, objects, benefits and advantages which have been discussed are merely illustrative. None of them, nor the discussions relating to them, are intended to limit the scope of protection in any way. Numerous other examples are also contemplated. These include examples which have fewer, additional, and/or different components, steps, features, objects, benefits and advantages. These also include examples in which the components and/or steps are arranged and/or ordered differently.

Unless otherwise stated, all measurements, values, ratings, positions, magnitudes, sizes, and other specifications which are set forth in this specification are approximate, not exact. They are intended to have a reasonable range which is consistent with the functions to which they relate and with what is customary in the art to which they pertain.

What is claimed is:

1. A system for solar energy conversion comprising:
a photoelectric cell comprising:
a cathode; and
an anode comprising a nanostructure array,
wherein the nanostructure array comprises:
a semiconductor photocatalyst; and
a plasmon resonant metal nanostructure film arranged on the semiconductor photocatalyst.

2. The system for solar energy conversion of claim 1, wherein the semiconductor photocatalyst is at least one selected from the group consisting of TiO₂, YbO, PbO, Fe₂O₃, ZnO, CdS, SiC, WO₃, and GaP, and any combination thereof.

3. The system for solar energy conversion of claim 1, wherein the plasmon resonant metal nanostructure film has a thickness of about 1 nm to about 10 nm.

4. The system for solar energy conversion of claim 1, wherein the plasmon resonant metal nanostructure film is not continuous and has island-shaped areas having a size of about 10 nm to about 30 nm in diameter.

5. The system for solar energy conversion of claim 4, wherein the island-shaped areas are separated from each other by a distance of about 1 nm to about 10 nm.

6. The system for solar energy conversion of claim 1, wherein the plasmon resonant metal nanostructure film is comprised of at least one selected from the group consisting of Au, Ag, Al, Cu and Pt, and any combination thereof.

7. The system for solar energy conversion of claim 1, wherein the plasmon resonant metal nanostructure film is arranged on a surface of the semiconductor photocatalyst.

8. The system for solar energy conversion of claim 1, wherein the absorption spectrum of the anode is in the visible region.

9. The system for solar energy conversion of claim 1, wherein the nanostructure array has a repeating pattern of shapes.

10. The system for solar energy conversion of claim 9, wherein the repeating pattern of shapes has a geometry of at least one selected from the group consisting of dots, rods, triangles, bowties, and crescents.

11. The system for solar energy conversion of claim 10, wherein the shapes have a size of from 10 to about 150 nm as measured along the longest axis.

12. The system for solar energy conversion of claim 1, wherein the semiconductor photocatalyst is doped with a dopant selected from the group consisting of V, Cr, Mn, Fe, Ni, N, any ion thereof and any combination thereof.

13. A method for producing methane comprising the steps of:
placing a photocatalytic cell in an environment containing CO₂; and
exposing the photocatalytic cell to visible light thereby allowing the CO₂ to be converted to methane,
wherein the photoelectric cell comprises: a cathode; and an anode comprising a nanostructure array, and the nanostructure array comprises: a semiconductor photocatalyst; and a plasmon resonant metal nanostructure film arranged on the semiconductor photocatalyst.

14. The method of claim 13, wherein the semiconductor photocatalyst is at least one selected from the group consisting of TiO₂, YbO, PbO, Fe₂O₃, ZnO, CdS, SiC, WO₃, and GaP, and any combination thereof.

15. The method of claim 13, wherein the plasmon resonant metal nanostructure film has a thickness of about 1 nm to about 10 nm.

16. The method of claim 13, wherein the plasmon resonant metal nanostructure film is not continuous and has island-shaped areas having a size of about 10 nm to about 30 nm in diameter.

17. The method of claim 16, wherein the island-shaped areas are separated from each other by a distance of about 1 nm to about 10 nm.

18. The method of claim 13, wherein the plasmon resonant metal nanostructure film is comprised of at least one selected from the group consisting of Au, Ag, Al, Cu and Pt, and any combination thereof.

19. The method of claim 13, wherein the plasmon resonant metal nanostructure film is arranged on a surface of the semiconductor photocatalyst.

20. The method of claim 13, wherein the absorption spectrum of the anode is in the visible region.

21. The method of claim 13, wherein the nanostructure array has a repeating pattern of shapes.

22. The method of claim 21, wherein the repeating pattern of shapes has a geometry of at least one selected from the group consisting of dots, rods, triangles, bowties, and crescents.

23. The method of claim 22, wherein the shapes have a size of from 10 to about 150 nm as measured along the longest axis.

24. The method of claim 13, wherein the semiconductor photocatalyst is doped with a dopant selected from the group consisting of V, Cr, Mn, Fe, Ni, N, any ion thereof and any combination thereof.
